(19) United States
(12) Patent Application Publication
(10) Pub. No.: US 2015/0364237 A1
(43) Pub. Date: Dec. 17, 2015

(54) SPRINGABLE MAGNETIC DEVICE

(71) Applicant: GUI GLOBAL PRODUCTS, LTD., Houston, TX (US)

(72) Inventor: Walter G. MAYFIELD, Houston, TX (US)

(21) Appl. No.: 14/764,889

(22) PCT Filed: Jan. 16, 2014
(86) PCT No.: PCT/US2014/011896

§ 371 Date: Jul. 30, 2015

Related U.S. Application Data
(60) Provisional application No. 61/768,704, filed on Feb. 25, 2013.
(60) Provisional application No. 61/758,549, filed on Jan. 30, 2013.

(51) Int. Cl. H01F 7/02; H01F 1/14; H01F 1/053

(52) U.S. Cl. CPC H01F 7/0221; H01F 1/053; H01F 1/14

(57) ABSTRACT

A magnetic device may have a matrix and a plurality of magnets, and the magnetic device may have a force sufficient to maintain a contracted position upon being contracted from a stretched state. The matrix may have at least two hinges that may be or include, but are not limited to a living hinge, a mechanical hinge, or combinations thereof. The plurality of magnets may be disposed upon, within, or around the matrix, and at least one dimension of each magnet is at least 500 nm. In a non-limiting embodiment, at least one of the magnets may be an energizable magnet for increasing or decreasing the rebound force of the magnetic device when the magnetic device is energized.

### TECHNICAL FIELD

The present invention relates to a magnetic device and methods of using the same where the magnetic device has a rebound force sufficient to cause the magnetic device to contract upon being released from a stretched state.

### BACKGROUND

Rare-earth magnets have been around since the 1970s; but their cost has only recently become competitive with conventional magnets. Since these magnets can achieve a magnetic field that is over 50% stronger than a conventional magnet, they have been employed in applications when a stronger magnetic field than that of a conventional magnet may be needed.

Springs have been known since ancient times, such as a bow to be used with an arrow; a spring is an elastic object used to store mechanical energy. When a spring is compressed or stretched, the force it exerts is proportional to its change in length. The rate or spring constant of a spring is the change in the force it exerts, divided by the change in deflection of the spring.

Springs that quickly regain their original shape after being deformed by a force, with the molecules or atoms of their material returning to the initial state of stable equilibrium, often obey Hooke's law. Hooke's law in simple terms says that stress is directly proportional to strain. Stated another way, the more you stretch a spring the more force it takes to keep stretching it. Many materials obey this law as long as the load does not exceed the material's elastic limit.

It would be desirable in the art of preparing springable devices, if such devices were not subject to Hooke's law.

### SUMMARY

There is provided, in one form, a magnetic device having a matrix and a plurality of magnets. The magnetic device may have a force sufficient to maintain a contracted state upon being contracted from a stretched state. The matrix may have at least two hinges that may be or include, but is not limited to a living hinge, a mechanical hinge, or combinations thereof. The plurality of magnets may be disposed upon, within, or around the matrix, and at least one dimension of each magnet is at least 500 nanometers (nm).

There is further provided in another embodiment a method for expanding or contracting a magnetic device by energizing the magnetic device. The magnetic device may have a force sufficient to maintain a contracted state upon being contracted from a stretched state. The magnetic device may have or include a matrix having a plurality of magnets disposed upon, within, or around the matrix, and the matrix may have at least two hinges comprising a living hinge, a mechanical hinge, or combinations thereof. At least one magnet is an energizable magnet for increasing or decreasing the rebound force of the magnetic device when the magnetic device is connected to a power supply. At least one dimension of each magnet is at least 500 nm.

### BRIEF DESCRIPTION OF THE DRAWINGS

FIG. 1 depicts a two-dimensional magnetic device in a stretched state;

FIG. 2 depicts a row of magnets within the magnetic device having alternating polarity;

FIG. 3 illustrates the magnetic device in a contracted state where the magnets have alternating polarity;

FIG. 4 depicts the magnetic device where a positive magnet and a negative magnet are overlain to form a strap;

FIG. 5 depicts the magnetic device having at least one insert to allow for an external stimuli;

FIG. 6 depicts a non-limiting example of a springable water hose;

FIG. 7 depicts an alternate version of the magnetic device having mechanical hinges;

FIG. 8 depicts a magnetic device where the matrix is covered by a coating/covering;

FIG. 9 is a depiction of the magnetic device where the magnetic device is partially stretched;

FIG. 10 is an illustration of the magnetic device in a fully stretched state and attached to a magnetic surface;

FIG. 11 is an illustration of the magnetic device having an object attached to at least one end;

FIG. 12 depicts a magnetic device having at least two rows of magnets where the rows are separated by the matrix;

FIG. 13 depicts the magnetic device attaching a first object to a second object;

FIG. 14 depicts a magnetic device attached to the cord of earbuds;

FIG. 15 illustrates an alternative embodiment of the magnetic device that includes a metal strap;

FIG. 16A depicts a row of magnets within the magnetic device having the same polarity;

FIG. 16B illustrates the magnetic device in a contracted state where the magnets have the same polarity;

FIG. 17A depicts a row of magnets and a non-magnetic material within the magnetic device;

FIG. 17B illustrates the magnetic device in a contracted state where the magnetic device has the non-magnetic material;

FIG. 18A is an illustration of the magnetic device as an exercise device where the exercise device also includes an exercise material;

FIG. 18B is an illustration of an exercise device having a substantially central portion as an exercise material;

FIG. 19 depicts the magnetic device used for strapping something to a non-magnetic material;

FIG. 20A depicts an exercise device where the magnetic device is attached to stationary posts;

FIG. 20B depicts an exercise device having a non-magnetic material;

FIG. 21 is an illustration of an exercise device having a pair of handles and at least two magnetic devices attached in parallel between the handles;

FIG. 22 depicts a magnetic device where the magnets may be sewn into the matrix and/or placed into pockets sewn into the matrix;

FIG. 23 depicts a magnetic spring strap having a plurality of magnets where the magnets are disposed on the matrix;

FIG. 24 depicts a bag having at least one magnetic device for lengthening or shortening the purse and/or handle of the purse; and

FIG. 25 depicts a row of magnets where each magnetic axis is parallel to the matrix instead of perpendicular to the matrix; and

FIG. 26 is similar to FIG. 25, but the magnetic polarity of the magnets follows a different pattern.

### DETAILED DESCRIPTION

It has been discovered that a magnetic device may have a plurality of magnets disposed upon, within, or around a matrix to give the magnetic device a spring-like quality that would not otherwise exist if the magnets or the matrix were used alone. The magnetic device has a springable characteristic due to the magnetic attractive force between the magnets, and the magnetic device returns to its contracted state once the force applied thereto is released. The magnetic device differs from a traditional spring in that it is not elastic like traditional springs. Thus, the magnetic device does not follow Hooke's law for the same reason.

The rebound force of the magnetic device is due to the magnetic field created by the plurality of magnets, and the matrix lends the magnetic device its structure. Due to the magnetic attractive force between the magnets, the magnetic device must have a force applied thereto to maintain a stretched state. In one non-limiting instance, such a force may be applied from a person, a machine, gravity, friction, magnetic attractive force between the magnetic device and another magnetic object, etc. Because of the magnetic attractive force between the magnets and also the lack of elasticity, the magnetic device also has a fairly constant force through its extension (stretched state) and retraction (contracted state or resting state).

The magnetic device may have several applications due to its unique spring-like properties, such as but not limited to a window treatment (e.g. blinds); a windshield shade; a swimming pool cover; attaching the magnetic device to a door, attic, etc.; a fire escape; a measuring tape; an animal lead or leash; earbud cables where the cables self-coil; an exercise device; a stretched magnetic strip; a tourniquet; keeping skis held within ski boots; downhole spring mechanism for oil and gas wireline tools; secure cargo to a rack; seatbelt extender; a therapeutic massage device; a robotic arm; an extendable strap for securing to a lock for locking an object to a gate, bicycle, etc.; attaching a ribbon to a gift; a lanyard; a toy having a retractable arm, leg, neck, or other body part; a refrigerator magnet to hold papers, pictures, or other objects; and combinations thereof. Alternatively, a magnetic device may connect two toys together to allow the two toys to have a spring-like effect between them.

Other non-limiting uses may include a watchband, a velcro substitute, a bungee cord substitute, a ponytail holder, a bracelet, a pant belt, a hat band, a neck exerciser, a greeting card, a map, an ornament, a stress relieving device, etc. Another non-limiting example similar to the bungee cord substitute is a magnetic device that enables a person to safely repel down from a helicopter, building, mountain, etc. In a non-limiting embodiment, the magnetic device may be used to close doors where the magnetic device pulls the door closed after it has been opened. The magnetic device may have a cloth-like matrix and may be used as a cleaning material. The cloth-like matrix may be a microfiber material in a non-limiting embodiment.

A stretched magnetic device may be applied to a magnetic surface where the stretched magnetic device may have metal objects attached thereto, such as but not limited to keys, tools, sports equipment, etc. Alternatively, the magnetic device may secure a non-metal object to a magnetic surface, such as but not limited to securing a ski boot into its bearings, or wrapping a water bottle with a magnetic device to secure it to a bicycle, etc. The magnetic device may be stored in its contracted state until the magnetic device is needed again. In an alternative embodiment, at least one end of the magnetic device may have something attached thereto for increasing the utility of the magnetic device, such as but not limited to hooks, handles, etc.

The magnetic device may have LED lights affixed thereto when the magnetic device is attached to a power supply. The LED-lit magnetic device may be adhered to the back of a car when the car is sitting on the side of a road or highway; this type of embodiment would allow the car driver to safely alert other drivers to the parked car. Alternatively, the LED-lit magnetic device could be used for advertising purposes where a person may adhere a banner or poster to a car by laying a banner or poster between the LED-lit magnetic device and the car.

The contraction of the magnetic device has a unique and rhythmic sound. In a non-limiting embodiment, the magnetic device may be used as a therapeutic device similar to the way one would use a stress ball. By manually expanding the magnetic device and contracting the magnetic device, a user may become lost in thought with a soothing noise. Alternatively, the same unique sound may be used at rallies, athletic events, and the like where several people manually contract and extend the magnetic device to amplify the sound. In yet another alternative embodiment, a non-electronic or electronic megaphone or another type of sound amplifier may amplify the unique sound.

The matrix may have any shape that has a stretchable characteristic that may also bend at pre-determined points on the matrix. That matrix gives the magnetic device its form, while also reducing the chipping and/or breaking of the magnets. The bendable characteristic may be achieved by at least one hinge, such as but not limited to a living hinge, a mechanical hinge, or combinations thereof. In a non-limiting embodiment, at least one of the magnets may be an energizable magnet for energizing the magnetic device when the magnetic device is attached to a power supply. In one non-limiting embodiment, the energizable magnet may be, but is not limited to wire coils wrapped around a ferromagnetic material. However, the energizable magnet may be any type of energizable magnet known to those skilled in the art.

The living hinge within the matrix of the magnetic device is a thin flexible hinge that is typically, but not necessarily, made from the same material as the material that is connected to the matrix; said differently, the living hinge is a fold or bend in the matrix. The material of the living hinge may be or include, but is not limited to a cloth-like material, a string, a cord, or material that is the same as the matrix. A mechanical hinge aids the rotation of the magnets, and the mechanical hinge may employ a more rigid matrix, such as but not limited to the use of a hinge that rotates around a pin, ball bearing, or other such device. The mechanical hinge functions similar to that of a living hinge, but is typically made from a different material than the matrix, such as but not limited to metal, plastic, leather, etc. Either type of hinge only allows a limited angle of rotation about a fixed axis of rotation.

The matrix allows the magnetic device to be stretched apart, while the magnets give the magnetic device a rebound force sufficient to contract the magnetic device upon release from a stretched state. The rebound force of the magnetic device may vary depending on the type of magnets in which to create the magnetic attractive force, e.g. the type of rare earth magnet used. The rebound force of the magnetic device may also vary depending on the magnet's mass as determined by the dimensions of the magnet, i.e. its volume as determined by the magnet's thickness, length, and width. The mass of the magnets has a direct correlation to the strength of the magnetic field created. For example, increasing the mass of the magnet will increase the magnetic force created and thereby increase the rebound force of the magnetic device. In addition, the mass of the magnets has a direct correlation to how the magnetic device functions. A magnetic device having smaller magnets may have less of a ‘jerking’ sensation that occurs when the magnetic device is released from a stretched state.

In one non-limiting embodiment, the majority of the matrix may stretch and contract in one dimension. The matrix may envelope the magnets, or the magnets may be disposed on the outside of the matrix, and combinations thereof. Essentially, the matrix functions as the backbone of the magnetic device and gives the magnetic device its structure; in one non-limiting embodiment, the magnetic device has an accordion type of structure when in a contracted state. The magnetic device may be stretched where it may be several times longer than the magnetic device in its contracted state, such as at least 2 times longer than the magnetic device in its contracted state, alternatively from about 5 times independently to about 20 times longer than the magnetic device, from about 7 times independently to about 14 times longer than the magnetic device, or from about 2 times independently to about 10 times longer than the magnetic device depending on the dimensions of the magnets and the length of separation between each magnet. As used herein with respect to a range, “independently” means that any lower threshold may be used together with any upper threshold to give a suitable alternative range.

The material of the matrix may be or include any material, such as but not limited to a mesh-like material, a cloth-like material, a metal, a plastic, nylon, Kevlar, Teflon, and combinations thereof. In one non-limiting embodiment, the matrix may have Velcro or some other type of adhesive device that aids in keeping the magnetic device in a contracted state. The thickness of the matrix depends on the use of the magnetic device. A thicker matrix material may require stronger magnets to create the same magnetic attractive force as compared to magnets used with a thinner matrix material. This is because a thicker matrix material separates the magnets to a greater extent than a thinner matrix material, and an increased separation of the magnets causes the magnetic attractive force to dissipate. The thickness of the matrix may vary throughout a magnetic device, which may be beneficial for allowing the separation of certain magnets prior to other magnets.

The matrix may have a coating or covering that may be or include but are not limited to a metallic coating, a magnetic coating, a resin coating, an epoxy, a ceramic material, a cloth-like material, a flexible type material, an interwoven fabric type material, a plastic type material, a reflective coating, and combinations thereof. The coating may partially or fully cover the matrix depending on the desired characteristics of the magnetic device; similarly, the thickness of the coating may depend on the desired characteristics of the magnetic device.

The matrix coating or covering may increase the ability of the magnetic device to stretch, contract, and the like. In addition or in the alternative, the matrix coating or covering may protect the matrix from extreme temperatures, pressures, or other conditions that would cause the magnetic device not to function properly. When using the magnetic device, the coating or covering may also prevent injury or damage to a person or surroundings external to the magnetic device should the magnetic device malfunction, such as but not limited to when the magnetic device rebounds into a contracted state upon being released from a stretched state.

In one non-limiting embodiment, the plurality of magnets may be arranged upon, within, or around the matrix in at least one row, alternatively from about 1 row independently to about 100 rows, alternatively from about 2 rows independently to about 50 rows. The magnets may be secured into or on the matrix by a mechanism, such as but not limited to sewing the magnets into the matrix, gluing the magnets into the matrix, injection molding the magnets into the matrix, heat bonding the magnets into the matrix, welding the magnets into the matrix, taping or similar adhesive of the magnets into the matrix, snapping the magnets into the matrix, or other mechanisms known to those skilled in the art of securing the magnets into the matrix.

The number of rows will depend on the desired size and shape the magnetic device has when in a stretched state and/or in a contracted state. The number of rows and columns will also depend on the strength and/or dimensions of the magnets used in the magnetic device. Columns are formed when the magnetic device has more than one row. The direction of the row or column is irrelevant; column is defined herein to be perpendicular to a row. A row may have a plurality of magnets in alternating directional polarity such that when columns begin to form, the columns have at least two magnets having the same directional polarity. For example, the top surface of the magnets in a row may alternate in polarity from north to south to north, and the same magnets would have a bottom surface that alternates in polarity from south to north to south, respectively.

The plurality of magnets may have or include at least one metal, such as but not limited to MnBi, MnAl, MnAlC, alloys of MnBi, alloys of MnAl, alloys of MnAlC, barium hexaferrite, strontium, hexaferrite, NdFeB, alloys of NdFeB, samarium cobalt magnetic materials, alloyed cobalt materials, hard magnetic nitride materials, hard magnetic carbide materials, or rare earth magnetic materials, iron, iron-cobalt alloys, or iron-based alloys including silicon steel, nickel iron permalloys, iron-cobalt-vanadium alloys, or high saturation soft ferrite materials and combinations thereof.

The plurality of magnets may be of a variety of shapes depending on the desired use of the magnetic device, e.g. circles, squares, rectangles, spheres, etc. The shape of the magnets may be uniform throughout the magnetic device, or the shape may vary throughout the magnetic device. The dimensions, i.e. thickness, length, and width of the magnets will also vary the tension added to the magnetic device when in a stretched state; said differently, a thicker, longer, and/or wider magnet will increase the strength of the magnets and thereby the rebound force of a magnetic device, or a particular section along the matrix of a magnetic device if the shape of the magnets varies throughout the magnetic device. Additionally, longer magnets also increase the length of the magnetic device when extended. Each magnet disposed upon, within, or around the matrix may have a magnetic attractive force directly related to the mass, i.e. dimensions of the magnets coupled together. ‘Rebound force’ is defined herein as the force required to contract the magnetic device when released from a stretched state.

At least one magnet may have a coating, such as but not limited to a metallic plating, an epoxy resin, plastic, and combinations thereof, or almost any coating to prevent oxidation to the magnets and/or reduce the brittleness of the magnets. In a non-limiting embodiment, the metallic plating may be or include metals, such as but not limited to gold, nickel, zinc, tin, silver, and combinations thereof. This type of metallic plating, as well as other magnet coatings mentioned, may protect the magnet under specific external conditions, such as but not limited to temperature changes, pressure changes, pH changes, corrosion, and the like. The magnet coating may also increase or decrease the magnetic force of the magnet. Additionally, the coating may be a thin shock absorbing material for absorbing some of the shock to the magnetic device and/or the magnets; the coating may have a force dampening effect. Such an effect may protect the brittle magnets when the magnetic device is contracted upon being released from a stretched state.

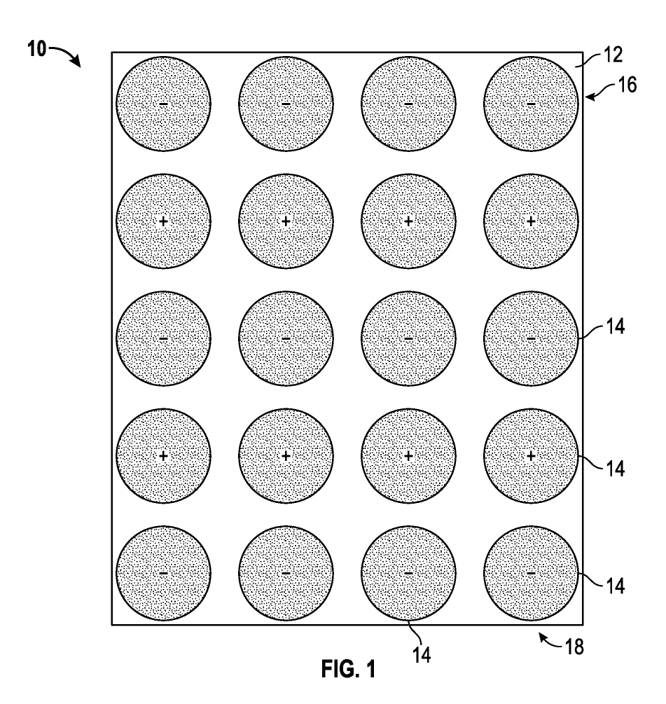

Turning to the Figures, FIG. 1 depicts a non-limiting embodiment of a two-dimensional magnetic device 10 when the magnetic device is in a stretched state. The magnetic device 10 includes a matrix 12 having a plurality of magnets 14 disposed thereon or therein. The matrix 12 may have columns 16 and rows 18. An external force must be applied to at least one end of the matrix in order for the magnetic device 10 to be flat and/or in a stretched state because the natural resting position of the magnetic device is for the magnetic device to be in a contracted state, as depicted in FIG. 3.

Each magnet in a row or column may be spaced apart such that the length of the space is sufficient to provide for at least one hinge; alternatively the length of space between each row and/or column may be the length of at least one magnet. The space between the magnets may function as a living hinge when the magnetic device is in a contracted state. Alternatively, a mechanical hinge may be placed between at least two magnets.

The space between the magnets may include a substance, such as but not limited to non-magnetic particles, non-magnetic ions, non-magnetic compounds, and combinations thereof. The non-magnetic particles or ions may be or include, but not limited to copper, aluminum, epoxy, polymer resin, or ceramic materials including alumina, and combinations thereof or any non magnetic ferrimagnetic or ferromagnetic material. The size of the non-magnetic particles may range from about 1 mm independently to about 1 cm.

A useful non-limiting example of a magnetic device having the configuration of that in FIG. 1 may be a map, a set of blinds, and the like where the magnetic device may be pulled in a down direction when hanging on a wall.

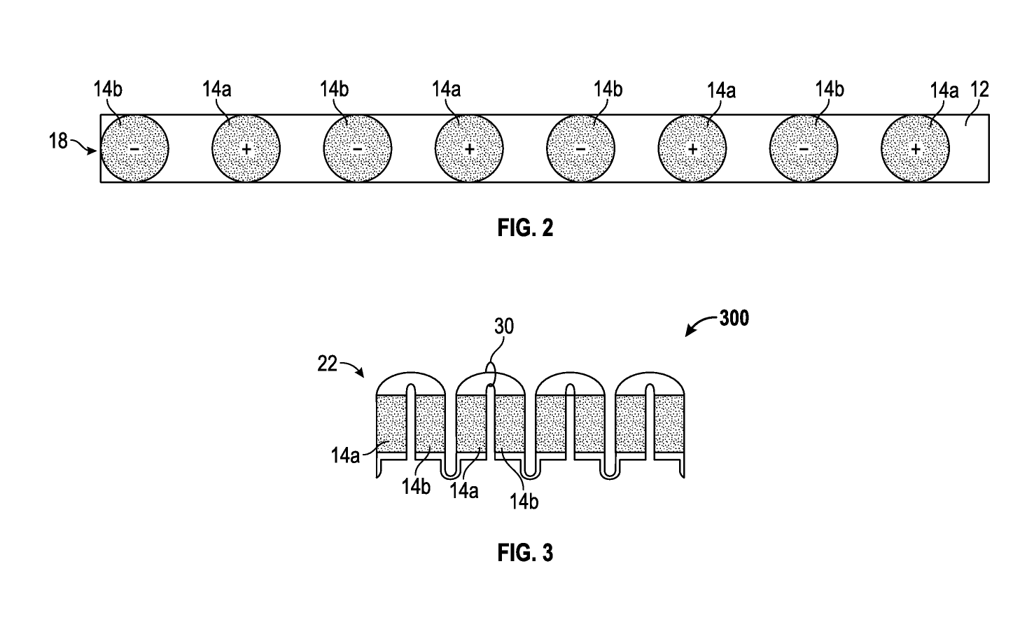

FIG. 2 depicts a row 18 of magnets 14a,b where the shown face of every other magnet 14 is of an alternating directional polarity when the magnetic device is in a stretched state, i.e. a positive magnet face 14a, then a negative magnet face 14b, then a positive magnet face 14a, and then a negative face 14b, and so on. The magnets 14a, 14b are disposed within the matrix 12.

FIG. 3 illustrates the magnets 14 a,b where the magnetic device 10 is in a contracted state 300; the magnetic device has an accordion structure. Each coupled section 22 has two magnets where one magnet has a positive magnet face 14a next to a negative magnet face 14b such that each positive magnet face 14a of each coupled section 22 faces the same direction, and each negative magnet face 14b of each coupled section 22 faces the same direction. Said differently, all positive magnet faces 14a face to the right in FIG. 3, and all negative magnet faces face to the left. There is a hinge 30 between each magnet 14a, 14b of the coupled magnet 22. The hinge 30 may be a living hinge, a mechanical hinge, or a combination thereof.

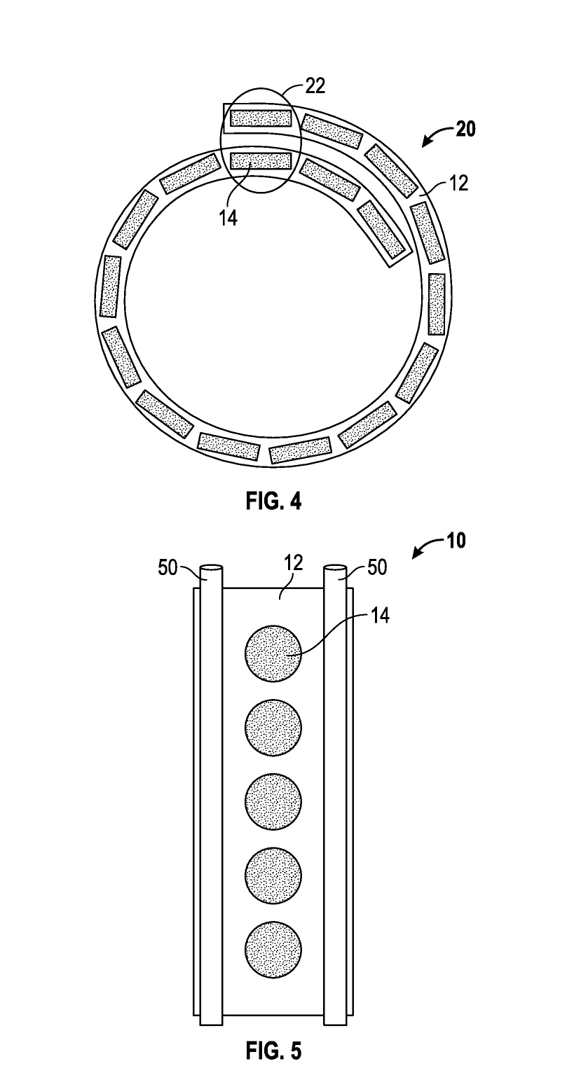

FIG. 4 depicts a non-limiting embodiment of the magnetic device as a strap 20 that forms when a positive magnet face 14a and a negative magnet face 14b are overlain to form a coupled magnet 22. The strap 20 may have magnets of alternating directional polarity, or it may have magnets where the magnets have the same directional polarity. For example, the magnets may have a top side that is a positive magnet face and a bottom side that is a negative magnet face; all magnets of the strap have the same directional polarity in this instance. Alternatively, the top sides of the magnets may alternate in directional polarity where every other magnet has a positive magnet face and then a negative magnet face; the magnets are said to have ‘alternating directional polarity’ in this instance.

The strap 20 may become stronger simply by overlaying an increased number of magnets together to form coupled magnets 22. Here, about three coupled magnets have formed; however, any number of coupled magnets may form depending on the intended purpose of the magnetic device. This type of strap 20 may have several applications that may be or include, but are not limited to a wrist band, a bundling device (e.g. for bundling wire, hair, cable, rope, a compression wrap, etc.), tourniquet, back brace, knee brace, ACE™ bandage, hat band, sweat band, collar, watch band, a velcro substitute, a bungee cord substitute, a ponytail holder, and the like. In one non-limiting embodiment, the matrix 12 and/or the magnets 14 of the strap 20 may be coated or covered with materials to give the magnetic device 10 additional strength or usage.

FIG. 5 depicts another non-limiting embodiment where the magnetic device 10 may have at least one insert 50, e.g. a tube, a cord, a wire etc. that allows for input to the magnetic device by an external stimuli. One or more inserts 50 may be used, even though two inserts are depicted here as a non-limiting embodiment. For example, a power supply may supply electricity to the magnetic device, or the inserts 50 may allow for an external pressure system to apply additional pressure to the magnetic device 10. The external stimulus may vary the strength of the current, magnetic attractive force, and/or force to aid the magnets 14 in stretching or contracting the magnetic device 10. In an alternative embodiment, the inserts 50 may allow for fluid to flow therethrough and create fluid pressure within the inserts 50 or throughout the matrix 12 that may increase or decrease the rebound force and/or the magnetic attractive force between the magnets 14.

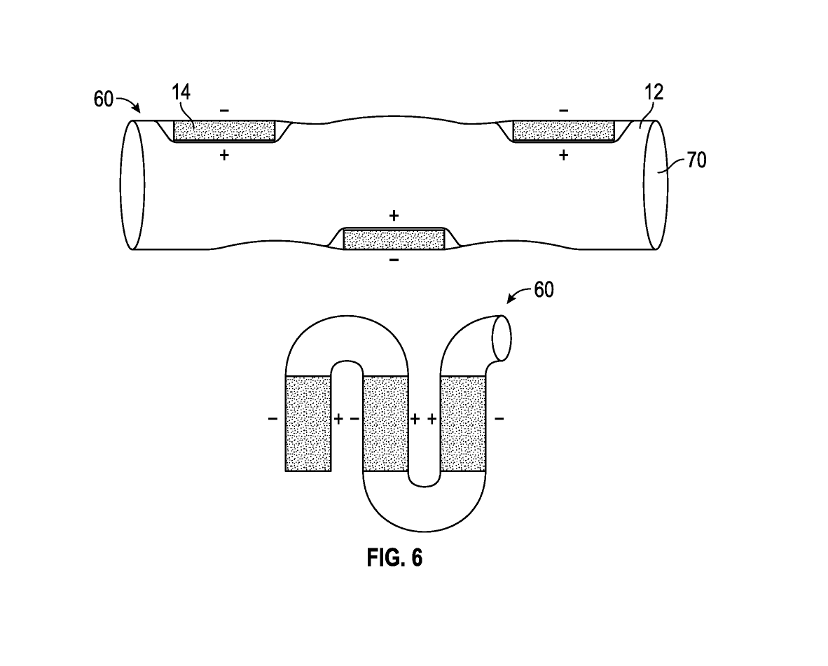

FIG. 6 depicts a non-limiting example of how an insert 50 might be used to provide a springable water hose 60. In this instance, the matrix 12 may be of a cylindrical shape having a hollow middle 70 therethrough that functions as the insert 50. Alternatively, the matrix 12 may be of an interwoven fabric with an inner elastic tube as the insert 50. Instead of having the magnets 14 disposed on the matrix 12 in rows 18 as depicted in FIG. 1, the magnets may be disposed on the outer portions of the matrix 12. Each magnet 14 has a positive side and a negative side, and when the magnetic springable water hose 60 is in a contracted state, it has a similar shape as depicted in FIG. 3.

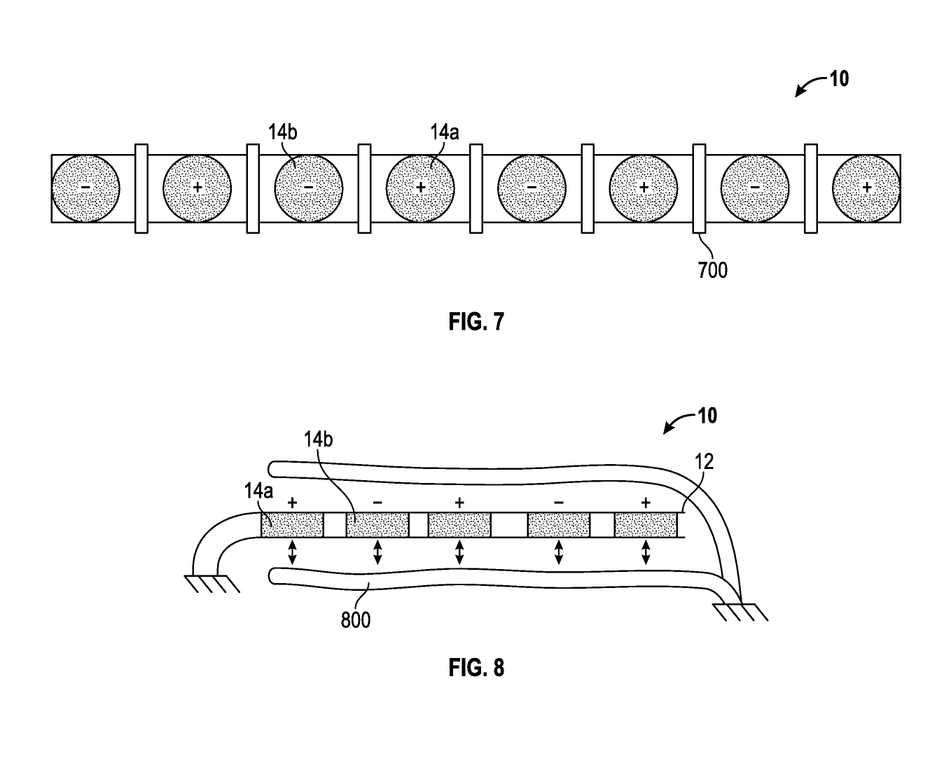

FIG. 7 depicts an alternate version of the magnetic device 10 having a plurality of magnets 14. Here, the face of magnets 14a,14b are shown to have alternating directional polarities, but the magnets may also have a uniform directional polarity for particular applications as discussed in FIG. 4 above. Between each magnet 14a,14b, there is a mechanical hinge 700. The mechanical hinge may increase or decrease the magnetic attractive force between the magnets in one non-limiting embodiment; alternatively, the mechanical hinge is non-magnetic.

FIG. 8 depicts a magnetic device 10 where the matrix 12 is covered by a coating/covering 800, which may enhance the durability of the matrix and/or reduce the magnetic force between at least two magnets. In one non-limiting instance, the coating/covering 800 is a flexible metal strap that may fully or partially envelope the magnetic device 10. The matrix 12 may be a material that increases the amount of friction between the matrix 12 and covering 800, such as but not limited to rubber, sand paper, etc.

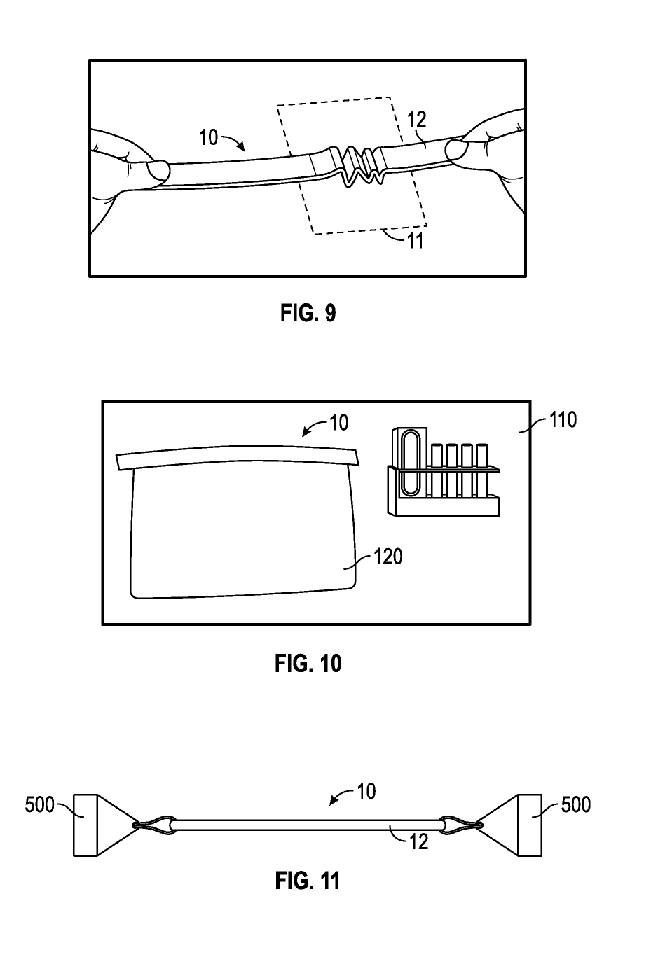

FIG. 9 is an illustration of the magnetic device where a portion of the magnetic device 10 is stretched, and a portion of the magnetic device is still in a contracted state. The magnets are enclosed within a matrix 12. In one non-limiting embodiment, the outermost portion of the magnetic device 10 may stretch first, as depicted here. Another unique characteristic of the magnetic device 10 is that if an imaginary box 11 were drawn around the contracted portion of the magnetic device 10, the ‘boxed’ portion 11 may be moved in either direction, but the ‘boxed’ portion 11 would maintain the same configuration and number of contracted magnets while doing so. Of course, the boxed portion 11 is not limited to a set number of contracted magnets for the magnetic device 10 to have this type of functionality.

In another non-limiting embodiment, the magnet shape and mass may be different throughout the magnetic device to allow the unfolding of certain magnets prior to the unfolding of other magnets. For example, magnets may increase in mass along the matrix to create an increasing magnetic attractive force along the magnetic device 10. Regardless, a completely stretched state of the magnetic device 10 occurs by separating/unfolding all of the magnets, where the magnetic device is unfolded and flat.

FIG. 10 is an illustration of the magnetic device 10 in a fully stretched state and attached to a magnetic surface 110, such as a whiteboard. The magnetic device 10 may be used to attach an object 120 to the magnetic surface 110 where the object 120 is between the magnetic device 10 and the magnetic surface 110. Alternatively, a magnetic object 120, such as keys, tools, etc may be attached onto the stretched magnetic device 10 even when the stretched magnetic device 10 is attached to a magnetic surface 110.

FIG. 11 is an illustration of the magnetic device 10 having an object 500 attached to at least one end, such as an exercise device in a non-limiting embodiment. The object 500 may be parallel or perpendicular to the magnetic device 10 depending on the intended purpose of the device. The object(s) 500 may be or include, but is not limited to a handle, a weight, a ball, a toy, clippers, fishing accessories, chapstick, security cards, keys, and the like. When the magnetic device is used as an exercise device. The matrix 12 may be or include an elastomeric material to give the magnetic device 10 an added elasticity. In a non-limiting embodiment, at least two objects 500 may be attached to at least one end of the magnetic device 10.

When used as an exercise device, the magnetic device 10 may be pulled on one or both ends for exercise purposes. The exercise device may also be used as a jump rope in one non-limiting embodiment. Here, the matrix 12 needs to be a material that is strong and durable, such as but not limited to nylon, Kevlar, and the like. In a non-limiting embodiment, the magnetic device 10 may have a weight (not shown) attached to one end of the magnetic device 10 (e.g. an exercise device) to allow variations in exercise methods. The weight may be more, less, or equal to the force necessary to separate the magnets within the magnetic device 10, i.e. the ‘separation force’. For instance, a weight having a force less than the separation force of the magnets may allow a user to use the magnetic device similar to the way one would use a yo-yo; a weight that is equal to the separation force of the magnets might be used where it would be beneficial to exercise with the magnetic device while the magnetic device is suspended in the air; a weight that is greater than the separation force of the magnets may keep the magnetic device 10 in a stretched state. The ‘weight’ may be or include any material, such as but not limited to metal, sand, a ball, a toy, or a container having liquid therein. In another non-limiting embodiment, there may be an object between two magnetic devices 10 or more to create a toy, exercise device, or other uses for such a device.

In a non-limiting embodiment, a magnetic device 10 may be a tape measure having clippers 500 attached to one end, and a carabineer 500 attached to the other end of the magnetic device 10. Such an embodiment would be useful for a fisherman to use the carabineer and hook the magnetic device to a shirt pocket when not using the magnetic device. Once a fish is caught, the tape measure may be extended to measure the fish, and the clippers may be used for fishing purposes also.

Another non-limiting embodiment of the magnetic device may be useful as a toy. A head may be an object 500 attached to the magnetic device 10 where the magnetic device appears similar to the body of a particular animal, and a tail may be another object 500 attached to the magnetic device 10 at the other end. The toy animal has been described where the toy has the magnetic device as the body, but any configuration would work, such as the magnetic device as the tail portion, an arm, leg, head, etc.

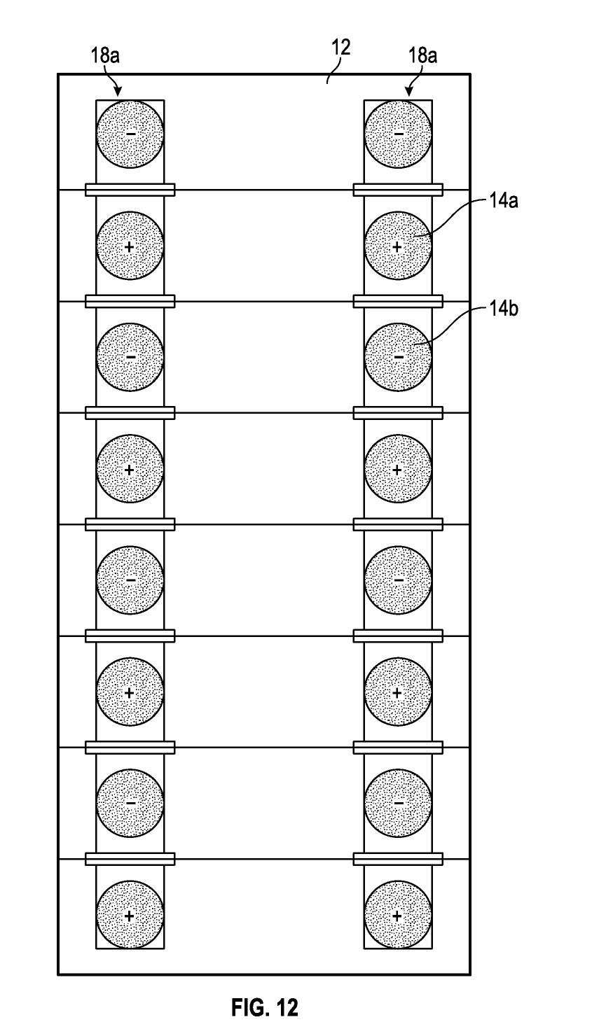

FIG. 12 depicts a magnetic device 10 having at least two rows 18a, 18b of magnets where the rows are separated by the matrix 12. Here the matrix 12 has a row 18a separated from another row 18b; each row 18a, 18b has a plurality of magnets 14a, 14b of alternating directional polarity attached thereto. The magnetic device 10 having a cover in a stretched state may be used to cover something. For example, the magnetic device may have a cloth-covering as part of the device. The cloth-covered magnetic device 10 may then function as a window shade, a pool cover, a car visor extender, etc. In this instance, the magnetic device 10 may also include an electromagnet and a power supply, so that the power supply may power the magnetic device 10 into a stretched state and/or a contracted state. Additionally, the magnets may have a greater space between at least two magnets, so the magnetic device when stretched remains in a stretched state until further assistance is given manually, electronically, with fluid pressure, or otherwise to retract into a contracted state.

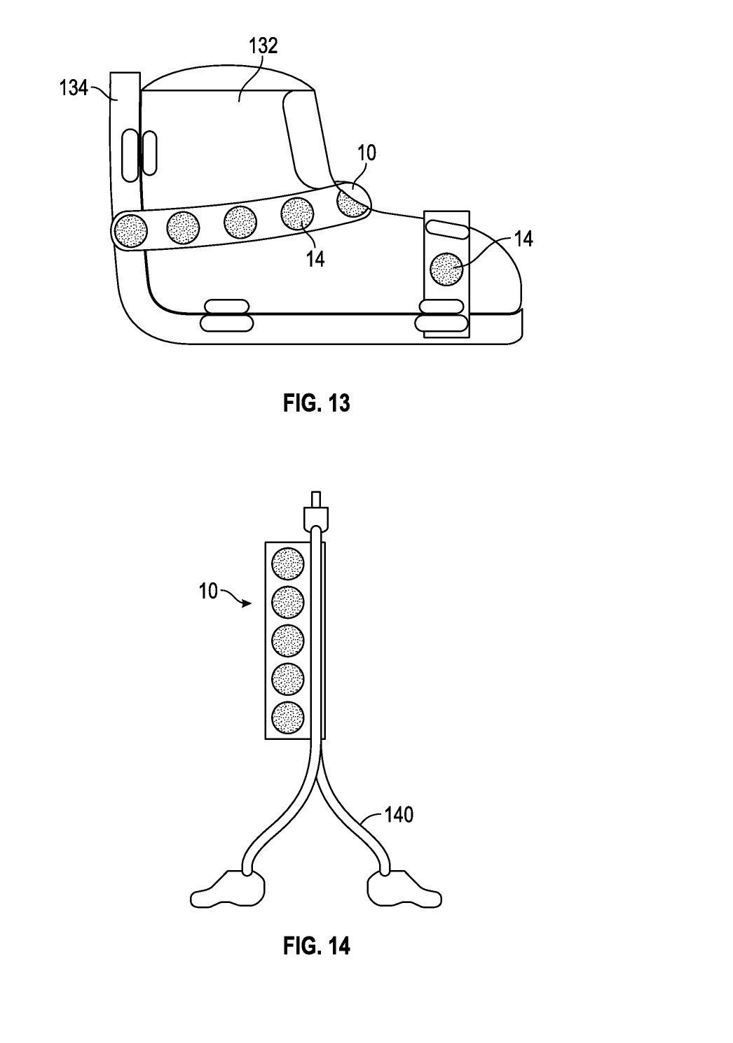

FIG. 13 depicts the magnetic device 10 attaching a first object 132 to a second object 134. The first object 132 is adjacent to the second object 134, and the magnetic device 10 is wrapped around both the first object 132 and the second object 134. Here, the first object 132 is depicted as a ski boot, and the second object 134 is depicted as the ski bearings. In this example, the ski boot is more securely attached to the ski bearings, and therefore, the ski boots are more securely attached to the skis (not shown). Other similar examples of such a mechanism include attaching a water bottle to a bicycle, a snow boot to a snow board, as well as the description in FIG. 19 below, etc.

FIG. 14 depicts a magnetic device 10 attached to the cord 140 of earbuds. The magnetic device 10 may be used to retract the cord 140 of the earbud wires in an accordion shape when the earbuds are not in use.

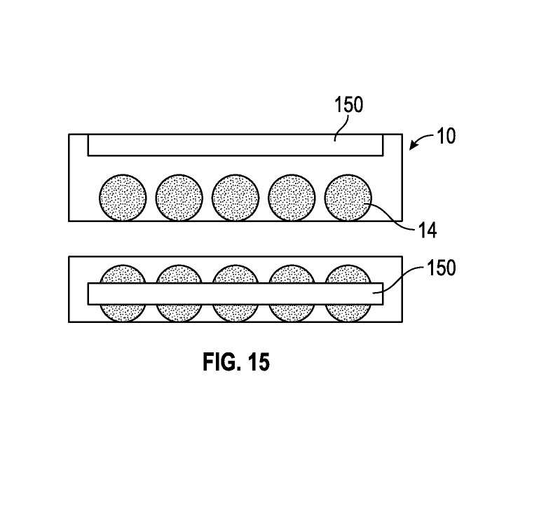

FIG. 15 illustrates an alternative embodiment of the magnetic device 10 that includes a metal strip 150. The metal strip 150 may be folded or placed on top of a row of magnets 14 to prevent the magnets 14 from rebounding into a contracted state.

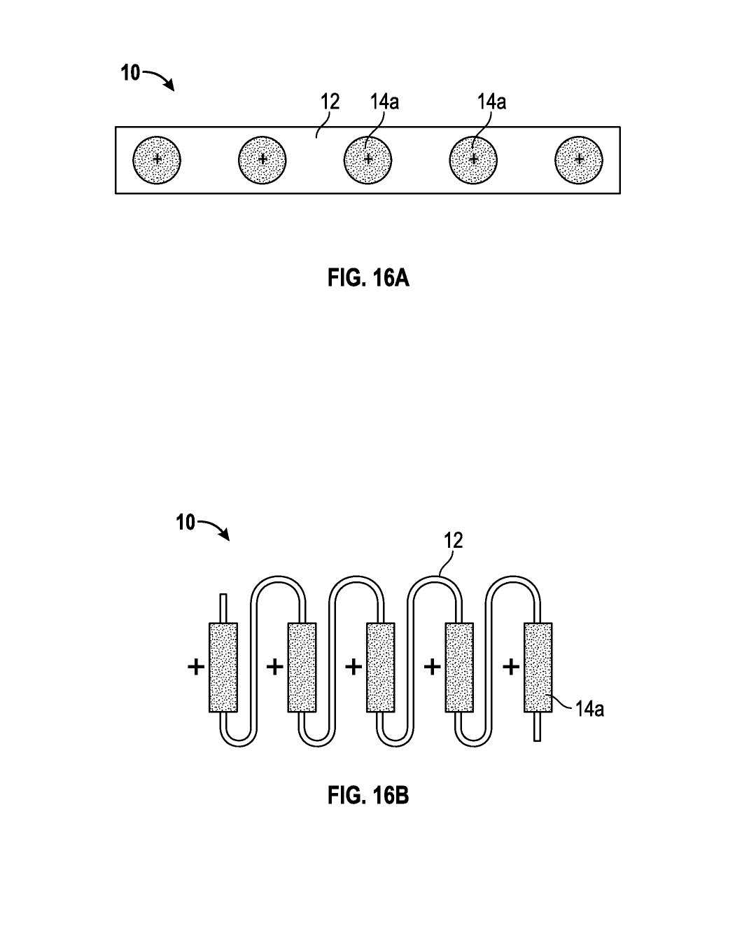

FIG. 16A depicts a magnetic device 10 having a row of magnets 14 of the same polarity within the matrix 12, and the matrix is in a stretched state. The top magnetic face is the same polarity across at least a portion of the magnetic device 10, and the bottom magnetic faces are the same polarity across at least a portion of the magnetic device; however, the top magnetic face is the opposite of the bottom magnetic face. For example, the magnets 14 are depicted as having a positive top magnetic face and a negative bottom magnetic face (not shown); however, the magnets could be oriented such that they have a negative top magnetic face and a positive bottom magnetic face. This is what is meant by ‘same polarity’ with regards to the magnetic device. In a non-limiting embodiment, the magnetic device may have at least one magnetic portion where the magnets have alternating polarity and at least one magnetic portion where the magnets have the same polarity.

FIG. 16B illustrates the magnetic device 10 of FIG. 16A in a contracted state where the magnets 14a have the same polarity within the matrix 12. The magnets are shown here as having a positive top magnetic face, but the magnets may have a negative top magnetic face in an alternative embodiment. Similar to FIG. 3, when the magnetic device 10 is in a contracted state, each positive magnet face 14a faces the same direction, and each negative magnet face 14b faces the same direction. Said differently, all positive magnet faces 14a face to the left, and all negative magnet faces face to the right as illustrated in FIG. 16B.

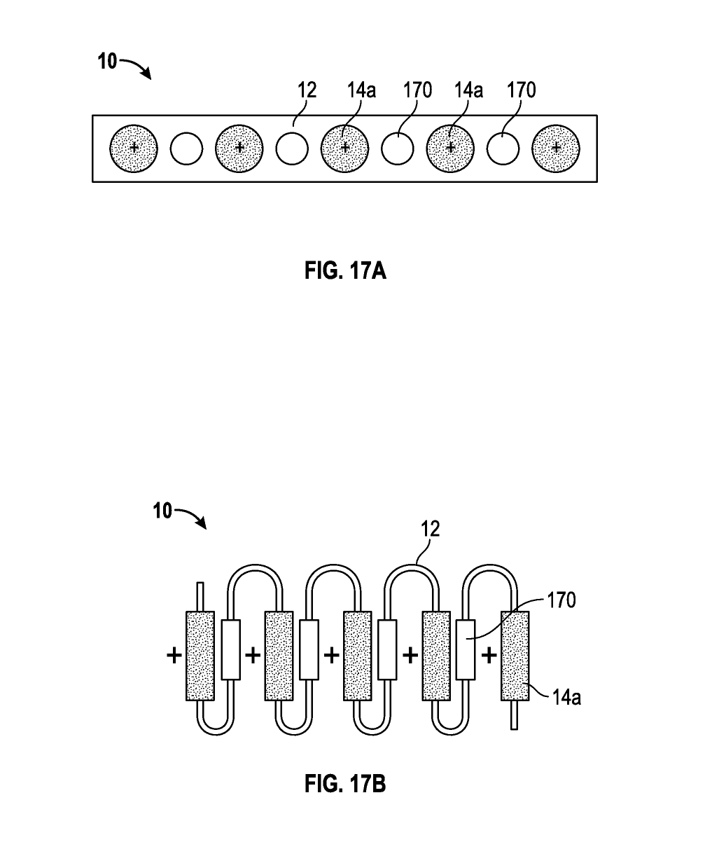

FIG. 17A depicts a row of magnets 14a and a non-magnetic material 170 within the magnetic device 10. The non-magnetic material 170 may be or include, but is not limited to non-magnetic particles, non-magnetic ions, non-magnetic compounds, and combinations thereof. The non-magnetic particles or ions may be or include, but not limited to copper, aluminum, epoxy, polymer resin, or ceramic materials including alumina, and combinations thereof or any non-magnetic ferrimagnetic or ferromagnetic material. In one non-limiting example, the non-magnetic material 170 may be ferrimagnetic or a ferromagnetic disk or particle between at least two magnets within the magnetic device. The ferromagnetic disk or particle may aid the contraction of the magnetic device when the magnets are of the same polarity within the extended matrix.

The size of the non-magnetic material 170 may be the same size, or smaller, as the magnets used within the magnetic device 10. Alternatively, the non-magnetic material may not be smaller than 500 nm in one non-limiting embodiment, or may range in size from about from about 1 micrometer independently to about 1 cm.

FIG. 17B illustrates the magnetic device 10 of FIG. 17a in a contracted state where the magnetic device 10 has the non-magnetic material 170, and the magnets 14a have the same polarity. The magnets are shown here as having a positive top magnetic face, but the magnets may have a negative top magnetic face in an alternative embodiment.

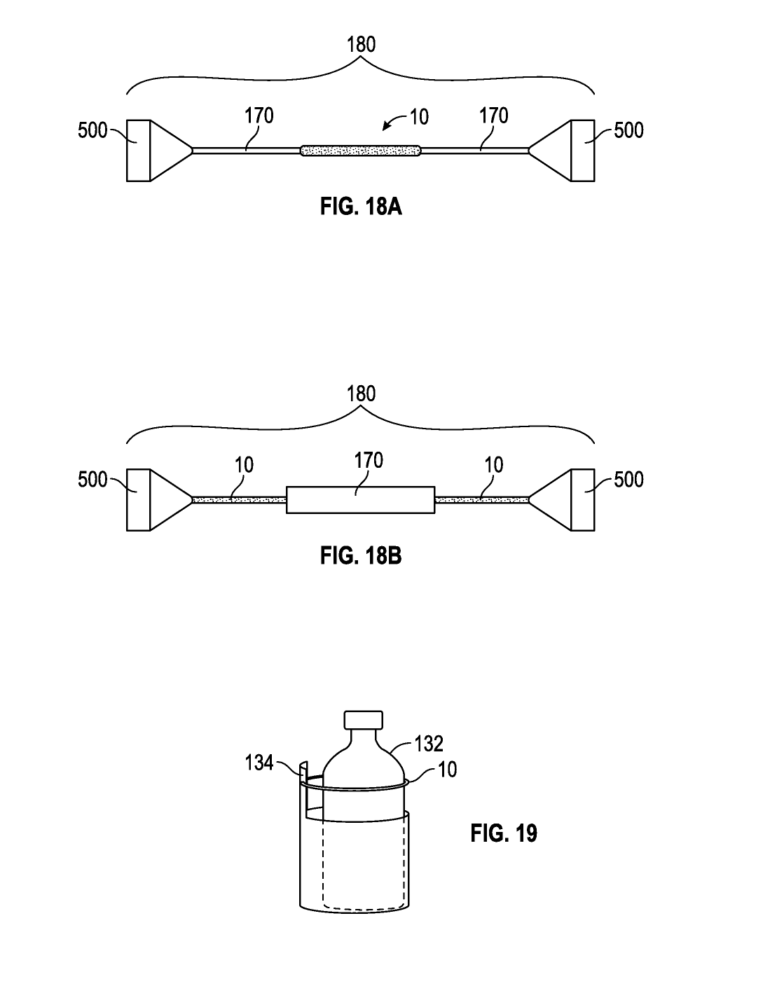

FIG. 18A is an illustration of the magnetic device 10 within an exercise device 180 where the exercise device 180 also includes an exercise material 170. The exercise material 170 may be or include, but is not limited to an elastic material, a nylon material, a cloth-like material, and combinations thereof.

The exercise device 180 may have at least two exercise material 170 portions. The exercise device 180 is depicted as having two optional handles 500; however, the handles 500 may be replaced with a similar functioning apparatus, such as a ball, or the handles 500 may be removed altogether.

The exercise device 180 is depicted here where the magnetic device 10 is a substantially central portion, and the exercise device 180 has an exercise material 170 on either side of the magnetic device 10. However, the exercise material 170 may be the substantially central portion, and a magnetic device 10 is on either side of the exercise material 170 (FIG. 18B) depending on the use of the exercise device 180.

In alternative embodiments, the exercise device 180 may have at least two exercise material portions 170 and at least two magnetic devices 10. The type of exercise device having at least two exercise material portions 170 and at least two magnetic devices 10 may have the exercise material portion 170 alternating with the magnetic device 10. Alternatively, there may be at least two exercise material portions 170 followed by at least two magnetic devices 10 within the exercise device 180. Those skilled in the art would understand how to configure such an exercise device 180.

The exercise material 170 functions to increase or reduce the amount of the resistance to the exercise device 180 in one embodiment. In addition to or alternatively, the exercise material 170 conforms to a body part for additional exercise to a specific area of the body. For example, in FIG. 18B, the exercise device 180 has a substantially central portion that is an exercise material 170, and a magnetic device 10 is on both sides of the exercise material 170. Here, the exercise material 182 may conform to a person's back in a non-limiting embodiment. The magnetic device on either side of the exercise material 170 would allow a person to use the exercise device 180 to exercise their arms, while the exercise material 170 is conformed to the person's back.

FIG. 19 depicts a non-limiting embodiment where the magnetic device 10 wraps around a first object 132 adjacent to a second object 134. Specifically illustrated is a magnetic device 10 wrapped around a water bottle 132 to more securely attach it into a cup holder 134. The cup holder 134 may be attached within a car, attached to a bicycle or motorcycle, a backpack, and the like.

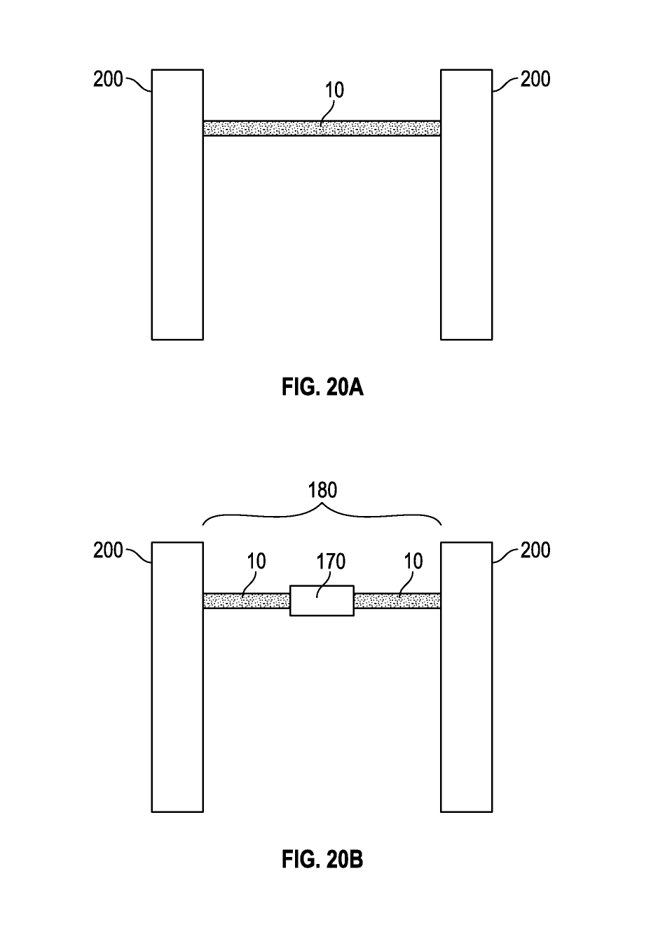

FIG. 20A depicts an exercise device 180 where the magnetic device 10 is attached to stationary posts 200. Alternatively, the exercise device 180 may also include a non-magnetic material 170 as shown in FIG. 20B. Here, the non-magnetic material 170 is substantially central within the exercise device 180; however, the location of the non-magnetic device may vary depending on the use of the non-magnetic material 170. Non-limiting examples of the non-magnetic material 170 may be or include a handle, a squeezable ball, an exercise material (such as the exercise material 182 depicted in FIG. 18A above), a weight, and the like. A non-limiting example of the exercise device 180 may have stationary posts 200 that are about the height of a person.

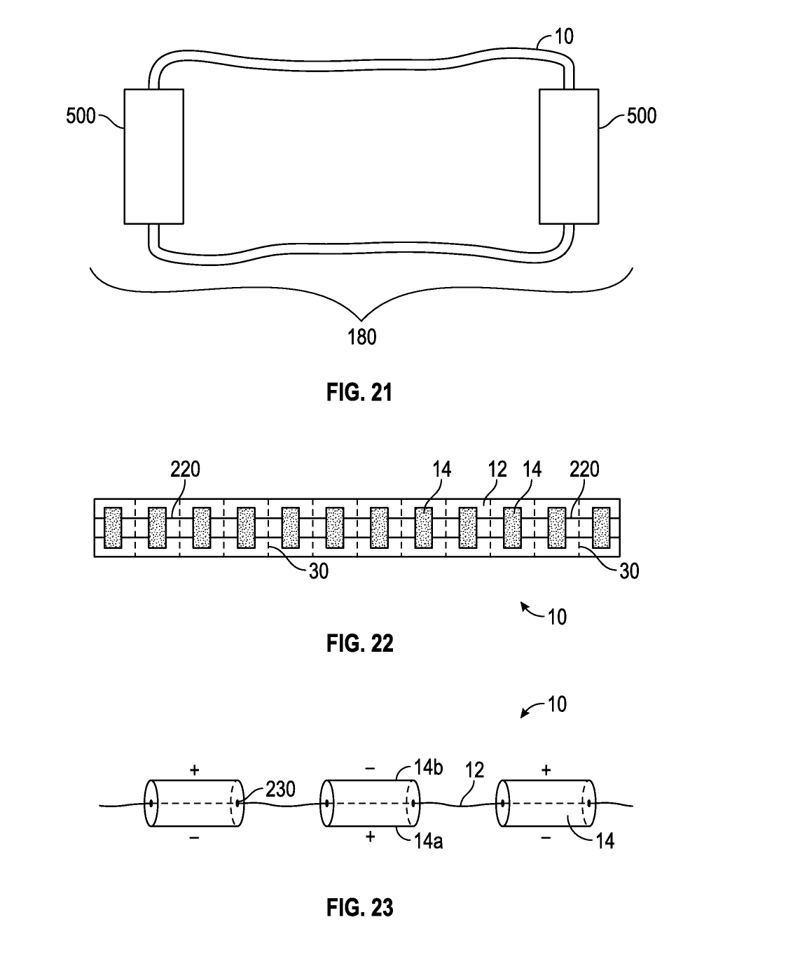

FIG. 21 is an illustration of an exercise device 180 having a pair of handles 500 and at least two magnetic devices 10 attached in parallel between the handles 500. Attaching at least two magnetic devices in parallel may increase the tension for the exercise device 180 for particular exercises. The magnetic device 10 may have non-magnetic material 170 strategically placed within the magnetic device 10.

FIG. 22 depicts a magnetic device 10 where the magnets 14 may be sewn into the matrix 12. A living hinge 30 may form at the fold when the magnetic device 10 folds into a contracted state. No adhesive is needed to bond the matrix 12 to the magnets 14; however, optional adhesive may be added for additional bonding of the magnets 14 to the matrix 12. The magnets 14 sewn into the matrix 12 may have the same polarity and/or alternating polarity depending on the desired use of the magnetic device 10.

Alternatively, the magnetic device 10 may have optional pockets 220 sewn into the matrix 12 where the magnets 14 are placed into the pockets 220. The magnets 14 could be easily replaced if chipped or broken, and/or the polarity of the magnets 14 may be easily changed. For example, if the magnets 14 have the same polarity in one instance, the polarity of the magnets 14 may be switched to have alternating polarity, and vice versa, depending on the function of the magnetic device 10.

FIG. 23 depicts a magnetic spring strap 10 having a plurality of magnets 14 disposed on the matrix. Each magnet 14 has a hole 230 therethrough where the matrix 12 may be disposed within each magnet 14. The magnetic spring strap 10 is depicted as having alternating polarity; however, it may have magnets 14 with the same polarity. When contracted, the magnetic spring strap 10 may configure to the orientation depicted in either FIG. 3 or FIG. 16B depending on the polarity of the magnets 14. Moreover, the magnets 14 are depicted here as cylinders, but the magnets may have any shape, e.g. rectangle, square, etc.

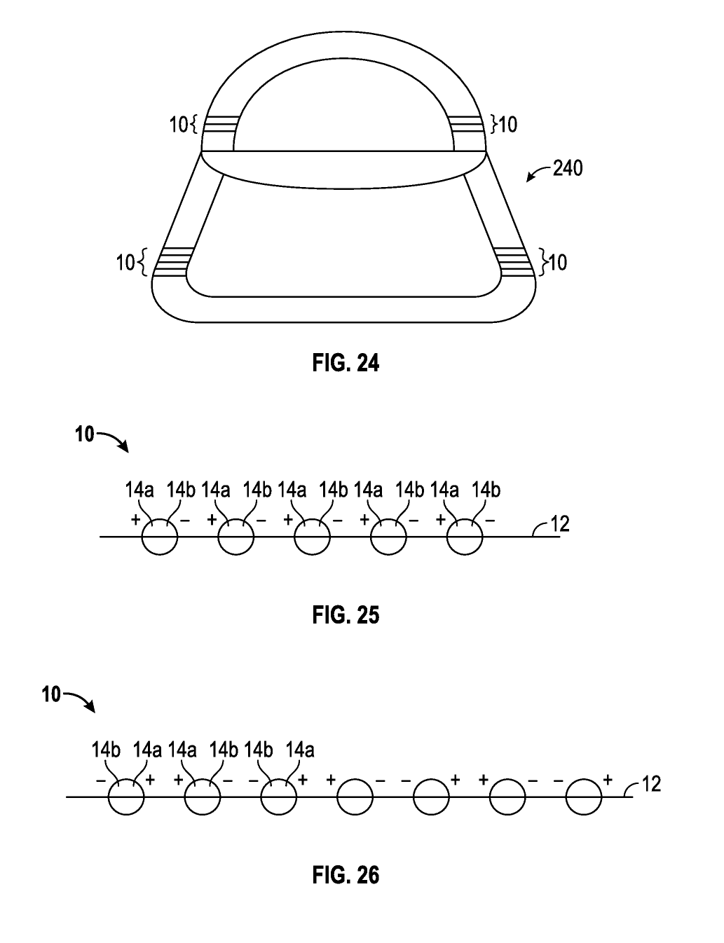

FIG. 24 depicts a bag, such as a purse 240 in a non-limiting embodiment, having at least one magnetic device 10 for lengthening or shortening the purse 240 and/or handle 245 of the purse 240 in a non-limiting embodiment. Clothing items may be lengthened or shortened in a similar manner, such as inserting a magnetic device into at least one pant leg or sleeve of a shirt. The magnetic device may be in an extended state when the user wants the clothing to be pants, but the magnetic device may be contracted to form shorts or capris pants. Similarly, a tie may have a magnetic device sewn into it for lengthening or shortening the tie.

FIG. 25 depicts a row of magnets 14 where each magnetic axis is substantially parallel to the matrix 12 instead of substantially perpendicular to the matrix 12. (The magnetic axis is substantially perpendicular to the matrix in FIGS. 1-24). Here, the pattern of the polarity is (+)(−) (+)(−)(+)(−) (+)(−) and so on.

FIG. 26 is similar to FIG. 25 where each magnetic axis of each magnet is parallel to the matrix 12, but the pattern of the polarity is (−) (+) (+)(−)(−) (+)(+)(−)(−)(+)(+) and so on. Such a pattern on the same side of the matrix 12, lends a different configuration to the magnetic device. Each magnet will repel slightly from a neighboring magnet in a stretched state, and when in a contracted state, the magnets may slightly twist to obtain a proper position where opposite polarities are attracted to each other. Such a configuration may alleviate some of the stress and/or strain to the matrix in a contracted state.

In the foregoing specification, the invention has been described with reference to specific embodiments thereof, and has been described as effective in providing methods and devices for expanding or contracting a magnetic device having a force sufficient to maintain a contracted position upon being contracted from a stretched state. However, it will be evident that various modifications and changes can be made thereto without departing from the broader scope of the invention as set forth in the appended claims. Accordingly, the specification is to be regarded in an illustrative rather than a restrictive sense. For example, specific hinges, matrix materials, magnets, and types of metals falling within the claimed parameters, but not specifically identified or tried in a particular method or device, are expected to be within the scope of this invention.

The present invention may suitably comprise, consist or consist essentially of the elements disclosed and may be practiced in the absence of an element not disclosed. For instance, the magnetic device may consist of or consist essentially of a matrix having at least two hinges comprising a living hinge, a mechanical hinge, or combinations thereof; and a plurality of magnets disposed upon, within, or around the matrix, and wherein at least one dimension of each magnet is at least 500 nm. The magnetic device has a force sufficient to maintain a contracted position upon being contracted from a stretched state.

The method may consist of or consist essentially of expanding or contracting the magnetic device having a rebound force sufficient to contract the magnetic device upon release from a stretched state where the method comprises energizing the magnetic device.

The words “comprising” and “comprises” as used throughout the claims, are to be interpreted to mean “including but not limited to” and “includes but not limited to”, respectively.

1-15. (canceled)

16. A magnetic device comprising:
a matrix having at least two hinges comprising a living hinge, a mechanical hinge, or combinations thereof; and
a plurality of magnets disposed upon or within the matrix, and wherein at least one dimension of each magnet is at least 500 nm; and
wherein the magnetic device has a force sufficient to maintain a contracted position upon being contracted from a stretched state.

17. The magnetic device of claim 16, further comprising a rebound force sufficient to contract the magnetic device upon release from the stretched state.

18. The magnetic device of claim 16, wherein the matrix comprises a material selected from the group consisting of a mesh-like material, a cloth-like material, a metal, a plastic, and combinations thereof.

19. The magnetic device of claim 16, wherein the plurality of magnets comprise a metal selected from the group consisting of MnBi, MnAl, MnAlC, alloys of MnBi, alloys of MnAl, alloys of MnAlC, barium hexaferrite, strontium, hexaferrite, NdFeB, alloys of NdFeB, samarium cobalt magnetic materials, alloyed cobalt materials, hard magnetic nitride materials, hard magnetic carbide materials, or rare earth magnetic materials, iron, iron-cobalt alloys, or iron-based alloys including silicon steel, nickel iron permalloys, iron-cobalt-vanadium alloys, or high saturation soft ferrite materials, and combinations thereof.

20. The method of claim 16, wherein the matrix has a coating comprising a metal, a magnetic coating, a resin, an epoxy, a ceramic, and combinations thereof.

21. The method of claim 16, wherein at least one magnet has a coating material selected from the group consisting of a metallic plating, an epoxy resin, a plastic, and combinations thereof.

22. The magnetic device of claim 16, wherein at least one dimension of the magnetic device in a stretched state is at least two times longer than the magnetic device in a contracted form.

23. The method of claim 16, wherein the matrix further comprises non-magnetic particles selected from the group consisting of copper, aluminum, epoxy, polymer resin, or ceramic materials including alumina, and combinations thereof.

24. The magnetic device of claim 16, further comprising a space between at least two magnets, wherein the length of the space is sufficient to provide for at least one hinge.

25. The magnetic device of claim 16, wherein the majority of the matrix is configured to stretch and contract in at least one dimension.

26. The magnetic device of claim 16, wherein the matrix further comprises at least one energizable magnet.

27. The magnetic device of claim 26, further comprising a power supply attached to the magnetic device.

28. A method for expanding or contracting a magnetic device having a rebound force sufficient to contract the magnetic device upon release from a stretched state, wherein the method comprises energizing the magnetic device, and wherein the magnetic device comprises:
a matrix having at least two hinges comprising a living hinge, a mechanical hinge, or combinations thereof; and
a plurality of magnets disposed upon or within the matrix, and wherein at least one dimension of each magnet is at least 500 nm; and
wherein at least one magnet is an energizable magnet for increasing or decreasing the rebound force of the magnetic device when the magnetic device is connected to a power supply.

29. The method of claim 28, wherein the matrix comprises a material selected from the group consisting of a mesh-like material, a cloth-like material, a metal, a plastic, and combinations thereof.

30. The method of claim 28, wherein the plurality of magnets comprise a metal selected from the group consisting of MnBi, MnAl, MnAlC, alloys of MnBi, alloys of MnAl, alloys of MnAlC, barium hexaferrite, strontium, hexaferrite, NdFeB, alloys of NdFeB, samarium cobalt magnetic materials, alloyed cobalt materials, hard magnetic nitride materials, hard magnetic carbide materials, or rare earth magnetic materials, iron, iron-cobalt alloys, or iron-based alloys including silicon steel, nickel iron permalloys, iron-cobalt-vanadium alloys, or high saturation soft ferrite materials, and combinations thereof.

31. The method of claim 28, wherein the matrix has a coating comprising a metal, a magnetic coating, a resin, an epoxy, a ceramic, and combinations thereof.

32. The method of claim 28, wherein at least one magnet has a coating material selected from the group consisting of a metallic plating, an epoxy resin, a plastic, and combinations thereof.

33. The method of claim 28, wherein at least one dimension of the magnetic device in a stretched state is at least two times longer than the magnetic device in a contracted form.

34. The method of claim 28, wherein the matrix further comprises non-magnetic particles selected from the group consisting of copper, aluminum, epoxy, polymer resin, or ceramic materials including alumina, and combinations thereof.

35. The method of claim 28, further comprising a space between at least two magnets, wherein the length of the space is sufficient to provide for at least one hinge.

36. The method of claim 28, wherein the space between the magnets includes a substance selected from the group consisting non-magnetic particles, non-magnetic ions, non-magnetic compounds, and combinations thereof.

37. The method of claim 28, wherein the majority of the matrix is configured to stretch and contract in at least one dimension.

38. The method of claim 28, further comprising a power supply attached to the magnetic device.
